(19) United States
(12) Patent Application Publication
(10) Pub. No.: US 2026/0161382 A1
(43) Pub. Date: Jun. 11, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventor: Yutaro YASUDA, TOKYO (JP)

(21) Appl. No.: 19/408,521

(22) Filed: Dec. 4, 2025

(30) Foreign Application Priority Data
Dec. 9, 2024 (JP) 2024-214300

(51) Int. Cl. G06F 8/65; G06F 11/07

(52) U.S. Cl. CPC G06F 8/65; G06F 11/0766

(57) ABSTRACT

In a software update system, when it is determined that a software update process has failed due to the loss of power, a date and time information acquisition unit acquires date and time information after a power supply is restored, a log generation unit generates a log based on the date and time information acquired by the date and time information acquisition unit after the power supply is restored, and a log transmission unit transmits to a server device the log generated based on the date and time information acquired by the date and time information acquisition unit after the power supply is restored.

### CROSS-REFERENCE TO RELATED APPLICATIONS

This application is based upon and claims the benefit of priority from Japanese Patent Application No. 2024-214300 filed on Dec. 9, 2024, the contents of which are incorporated herein by reference.

### BACKGROUND OF THE INVENTION

### Field of the Invention

The present disclosure relates to a software update system, a software update device, a software update method, and a storage medium.

### Description of the Related Art

JP 2018-037022 A discloses an in-vehicle update system. The in-vehicle update system acquires an update program via a wireless communication device and updates the software of an electronic control unit of a vehicle via the acquired update program.

### SUMMARY OF THE INVENTION

A better software update system, a better software update device, a better software update method, and a storage medium storing a program that causes a computer to execute the better software update method are desired.

The present disclosure aims to solve the aforementioned problems.

A first aspect of the present disclosure is a software update system including a vehicle and a server device configured to communicate with the vehicle via a network, the software update system comprising: an update processing unit configured to perform a software update process for an electronic control unit provided in the vehicle; an update failure determination unit configured to determine whether the software update process has failed due to failure of a power supply that supplies power to the electronic control device; a date and time information acquisition unit configured to acquire date and time information; a log generation unit configured to generate a log containing information on the software update process and the date and time information acquired by the date and time information acquisition unit; and a log transmission unit configured to transmit the log generated by the log generation unit to the server device, wherein, in a case where the software update process is determined to have failed due to the failure of the power supply, the date and time information acquisition unit acquires the date and time information after the power supply is restored, the log generation unit generates the log based on the date and time information acquired by the date and time information acquisition unit after the power supply is restored, and the log transmission unit transmits the log generated based on the date and time information acquired by the date and time information acquisition unit to the server device after the power supply is restored.

A second aspect of the present disclosure is a software update system including a vehicle and a server device configured to communicate with the vehicle via a network, wherein the software update system comprises an update processing unit configured to perform a software update process for an electronic control device provided in the vehicle, a date and time information acquisition unit configured to acquire date and time information, a log generation unit configured to generate a log containing information on the software update process and the date and time information acquired by the date and time information acquisition unit, and a log transmission unit configured to transmit the log generated by the log generation unit to the server device, wherein the log transmission unit determines, before transmitting the log, whether or not the date and time information included in the log includes a predetermined numerical value, and in a case where it is determined that the date and time information included in the log includes the predetermined numerical value, the log transmission unit cancels transmission of the log, the date and time information acquisition unit reacquires the date and time information, the log generation unit regenerates the log containing the date and time information reacquired by the date and time information acquisition unit, and the log transmission unit transmits the log regenerated by the log generation unit to the server device.

A third aspect of the present disclosure is a software update device in the software update system according to the first aspect, including the update processing unit, the update failure determination unit, the date and time information acquisition unit, the log generation unit, and the log transmission unit.

A fourth aspect of the present disclosure is a software update device in the software update system according to the second aspect, including the update processing unit, the date and time information acquisition unit, the log generation unit, and the log transmission unit.

A fifth aspect of the present disclosure is a software update method for performing a software update process for an electronic control unit provided in a vehicle, the software update method comprising: an update processing step in which an update processing unit performs the software update process; an update failure determination step in which an update failure determination unit determines whether or not the software update process has failed due to failure of a power supply that supplies power to the electronic control unit; a date and time information acquisition step in which a date and time information acquisition unit acquires date and time information; a log generation step in which a log generation unit generates a log containing information on the software update process and the date and time information acquired by the date and time information acquisition unit; and a log transmission step in which a log transmission unit transmits the log generated by the log generation unit to a server device, wherein, in a case where the software update process is determined to have failed due to the failure of the power supply, in the date and time information acquisition step, the date and time information acquisition unit acquires the date and time information after the power supply is restored; in the log generation step, the log generation unit generates the log based on the date and time information acquired by the date and time information acquisition unit after the power supply is restored; and in the log transmission step, the log transmission unit transmits to the server device the log generated based on the date and time information acquired by the date and time information acquisition unit.

A sixth aspect of the present disclosure is a program that causes a computer to perform the software update method according to the fifth aspect.

According to the present disclosure, a better software update system, a better software update device, a better software update method, and a storage medium storing a program that causes a computer to execute the better software update method can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating a software update system according to an embodiment;

FIG. 2 is a flow diagram of a software update process according to one embodiment;

FIG. 3 is a flow chart showing a software update process performed by a software update device according to one embodiment;

FIG. 4 is a flow chart showing a software update process performed by a software update device according to one embodiment;

FIG. 5 is a flow chart showing a campaign application process performed by a server device according to one embodiment; and

FIGS. 6A and 6B are diagrams for explaining the operation of the software update device.

### DETAILED DESCRIPTION OF THE INVENTION

Conventionally, software update for a vehicle-mounted electronic control unit (ECU) was performed at a dealer or the like. Recently, vehicles capable of updating ECU software over the air (OTA) using wireless communication have been commercially available, and such vehicles can update ECU software without being brought to a dealer or the like.

In the software update process via OTA, the ECU may need to be restarted during the process of software activation. Therefore, software activation is performed during parking that is when a driving source such as a vehicle engine, a driving motor, or the like is stopped.

During software activation, the power supply powering the ECU may fail due to, for example, the removal of the vehicle's battery. In case of the loss of power (failure of a power supply), software activation is aborted. When the software activation is aborted, a log that contains information indicating that the software update process has failed is generated, and the log is transmitted to a server device that manages the software update.

The log contains date and time information. However, conventionally, when the software update process fails due to the loss of power, the log contains the date and time information that does not conform to the format because the process of acquiring the date and time information is not performed.

For example, in the date and time information conforming to the format indicating 14:17 on Oct. 31, 2024, it is represented by a 12-digit number, such as “202410311417”. An example of date and time information not conforming to the format is “000000000000”. This is the initial value of the date and time information, and because the date and time information is not acquired, the initial value is not updated and thus the log includes the initial value.

According to the present disclosure, even when the software update process fails due to the loss of power, it is possible to ensure that the date and time information that does not conform to the format is not included in the log.

### Embodiment

A software update system, a software update device, a software update method, and a program according to an embodiment will be described below with reference to the drawings. A program (computer program, computer software) according to the present embodiment may also be referred to as a computer program product. The computer program product is not limited to computer programs recorded on the recording medium, but also includes computer programs transmitted, distributed, and downloaded via the Internet or the like.

### Configuration of Software Update System

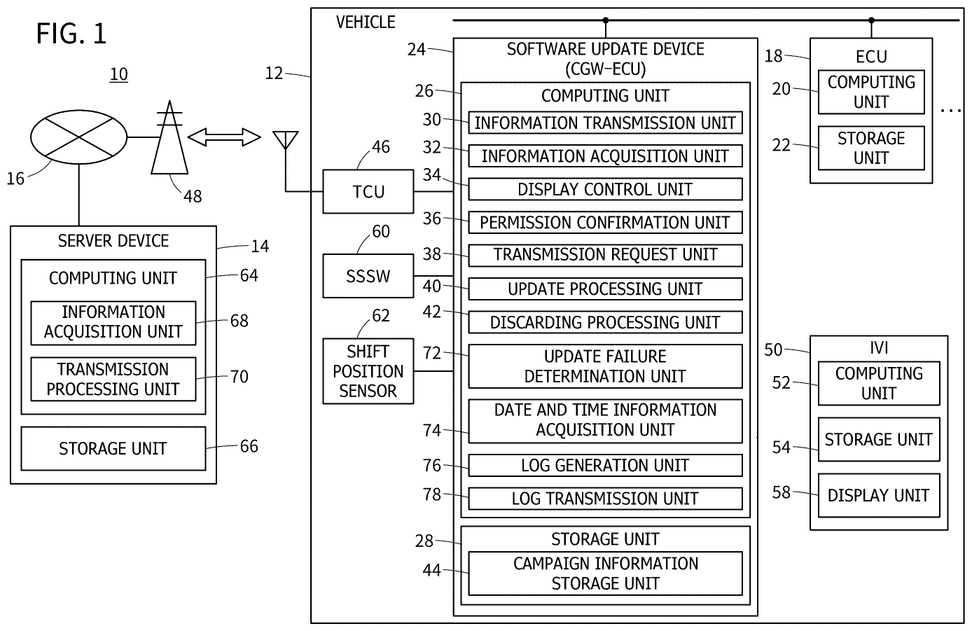

FIG. 1 is a schematic diagram illustrating a software update system 10 according to an embodiment. The software update system 10 includes a vehicle 12 and a server device 14. The server device 14 is capable of communicating with the vehicle 12 via a network 16.

The vehicle 12 is equipped with a plurality of ECUs 18. Each ECU 18 performs control to implement a traveling function and other functions of the vehicle 12. Each ECU 18 has a computing unit 20 and a storage unit 22. The computing unit 20 is a processor such as a CPU (Central Processing Unit), a GPU (Graphics Processing Unit), or the like. At least part of the computing unit 20 may be realized by an integrated circuit such as an ASIC (Application Specific Integrated Circuit), an FPGA (Field-Programmable Gate Array), or the like. At least part of the computing unit 20 may be realized by an electronic circuit including discrete devices.

The storage unit 22 is a computer-readable, non-transitory tangible storage medium. The storage unit 22 is composed of a volatile memory (not shown) and a nonvolatile memory (not shown). The volatile memory is, for example, RAM (Random Access Memory) or the like. The nonvolatile memory is, for example, ROM (Read Only Memory), flash memory, or the like. Data or the like is stored, for example, in the volatile memory. Programs, tables, maps, and the like are stored, for example, in the non-volatile memory. At least part of the storage unit 22 may be provided in the above-mentioned processor, integrated circuit, or the like. At least part of the storage unit 22 may be mounted in a device connected to the vehicle 12 via the network 16.

The vehicle 12 is equipped with a software update device 24. The software update device 24 may be constituted by, for example, a CGW-ECU (Central GateWay-Electronic Control Unit). The software update device 24 has a computing unit 26 and a storage unit 28. The computing unit 26 is, for example, a processor such as a CPU or a GPU. The computing unit 26 includes an information transmission unit 30, an information acquisition unit 32, a display control unit 34, a permission confirmation unit 36, a transmission request unit 38, an update processing unit 40, a discarding processing unit 42, an update failure determination unit 72, a date and time information acquisition unit 74, a log generation unit 76, and a log transmission unit 78. The information transmission unit 30, the information acquisition unit 32, the display control unit 34, the permission confirmation unit 36, the transmission request unit 38, the update processing unit 40, the discarding processing unit 42, the update failure determination unit 72, the date and time information acquisition unit 74, the log generation unit 76, and the log transmission unit 78 are implemented by the computing unit 26 executing programs stored in the storage unit 28. At least part of the information transmission unit 30, the information acquisition unit 32, the display control unit 34, the permission confirmation unit 36, the transmission request unit 38, the update processing unit 40, the discarding processing unit 42, the update failure determination unit 72, the date and time information acquisition unit 74, the log generation unit 76, and the log transmission unit 78 may be realized by an integrated circuit such as an ASIC, an FPGA, or the like. At least some of the information transmission unit 30, the information acquisition unit 32, the display control unit 34, the permission confirmation unit 36, the transmission request unit 38, the update processing unit 40, the discarding processing unit 42, the update failure determination unit 72, the date and time information acquisition unit 74, the log generation unit 76, and the log transmission unit 78 may be realized by an electronic circuit including discrete devices.

The storage unit 28 is a computer-readable, non-transitory tangible storage medium. The storage unit 28 is composed of a volatile memory (not shown) and a nonvolatile memory (not shown). The volatile memory is, for example, RAM or the like. The non-volatile memory is, for example, ROM, flash memory, or the like. Data or the like is stored, for example, in the volatile memory. Programs, tables, maps, and the like are stored, for example, in the non-volatile memory. At least part of the storage unit 28 may be provided in the above-mentioned processor, integrated circuit, or the like. At least part of the storage unit 28 may be mounted in a device connected to the vehicle 12 via the network 16. The storage unit 28 has a campaign information storage unit 44.

The software update device 24 performs the software update process for the ECU 18. The software update process includes software download, software installation, and software activation.

Software download means acquiring update data transmitted from the server device 14 via the network 16 and storing the data in the storage unit 28 of the software update device 24. The update data is data including a program or the like of the updated software. The update data may include an installer or the like.

Software installation means to load the update data of the storage unit 28 into the ROM of the ECU 18. The software installation may be performed by an installer. Software installation may be performed by copying update data to the ROM.

Software activation means the process of authenticating the license of installed software. During the activation of software, executable files, etc. used by the prior-to-updating software may be rewritten. Upon completion of the software activation, the execution of the software is allowed in the ECU 18. Activation may be performed by the software update device 24 or each ECU 18.

The information transmission unit 30 transmits various kinds of information to the server device 14. The information acquisition unit 32 acquires various kinds of information transmitted from the server device 14. The display control unit 34 controls an IVI 50, which is described later, to display campaign information, downtime permission confirmation information, or the like, which is described later, on the display unit 58 of the IVI 50. The permission confirmation unit 36 performs a confirmation process to confirm with the user whether to execute the software update process such as software download and software activation. The transmission request unit 38 transmits an update data request to the server device 14. The update data request is a signal for requesting the server device 14 to transmit update data to the software update device 24. The update processing unit 40 performs an update process of software download, software installation, and software activation. The discarding processing unit 42 performs a discarding process for discarding the acquired campaign information stored in the campaign information storage unit 44.

The update failure determination unit 72 determines whether the software update process has failed. When the software activation is aborted due to the failure of the power supply that supplies power to the ECU 18, the update failure determination unit 72 determines that the software update process has failed. On the other hand, when the software activation is completed, the update failure determination unit 72 determines that the software update process is successful. The date and time information acquisition unit 74 acquires information on the current date and time. The date and time information acquisition unit 74 may acquire the date and time information from signals transmitted from an artificial satellite used for GPS (Global Positioning System) or the like. The date and time information acquisition unit 74 may acquire the date and time information from the signals transmitted from the server device 14.

The log generation unit 76 generates a result log. The log generation unit 76 generates a result log when the software update process is completed, when the software update process is interrupted without completing the software update process, or when the software update process fails. The result log contains information about the software update process and the date and time information. The log generation unit 76 may generate an event log. The event log is generated when a predetermined process of the software update process starts or when the predetermined process ends. The log transmission unit 78 transmits the result log or the event log to the server device 14.

The software update device 24 and the ECU 18 are connected by a CAN (Controller Area Network) (registered trademark in Japan) and can communicate with each other. A communication line connecting the software update device 24 and the ECU 18 is not limited to the CAN and may be an Ethernet (registered trademark in Japan), or both the CAN and the Ethernet may be used. Furthermore, as the communication line, a communication line according to other standards than CAN and Ethernet may be used.

The software update device 24 can communicate, via a Telematics Control Unit (TCU) 46, with a base station 48 connected to the network 16 through cellular communication. The network 16 is, for example, the Internet.

The IVI 50 is connected to the software update device 24. The IVI 50 has a computing unit 52 and a storage unit 54. The computing unit 52 is, for example, a processor such as a CPU or a GPU.

The storage unit 54 is a computer-readable, non-transitory tangible storage medium. The storage unit 54 is composed of a volatile memory (not shown) and a nonvolatile memory (not shown). The volatile memory is, for example, RAM or the like. The non-volatile memory is, for example, ROM, flash memory, or the like. Data or the like is stored, for example, in the volatile memory. Programs, tables, maps, and the like are stored, for example, in the non-volatile memory. At least part of the storage unit 54 may be provided in the above-mentioned processor, integrated circuit, or the like. At least part of the storage unit 54 may be mounted in a device connected to the vehicle 12 via the network 16.

The IVI 50 provides information such as display of road traffic information and route guidance and also provides entertainment through audio, DVD, TV tuner, and so on.

The IVI 50 has a display unit 58. The display unit 58 is installed on a dashboard or the like of the vehicle 12. The display unit 58 is a touch panel display. The display unit 58 provides the user with information via images, characters, and so on and accepts operation input performed by the user. The screen of the display unit 58 is not particularly limited and may be a liquid crystal, organic electroluminescence (organic EL), or the like. The touch panel of the display unit 58 is not particularly limited and may be a resistive film type, a capacitance type, or the like. Instead of the display unit 58 that is a touch panel display, a combination of a display device such as a head-up display and a pointing device such as motion capture may be used.

The vehicle 12 is equipped with a start-stop switch (SSSW) 60. The power modes of the vehicle 12 is switched by the user operating the SSSW 60. When the vehicle 12 is an engine vehicle, the power modes include IG-ON, IG-OFF, ACC-ON, ACC-OFF, and START. When the vehicle 12 is a hybrid vehicle or a motorized vehicle, there are IG-ON, IG-OFF, ACC-ON, ACC-OFF, and READY.

In the IG-ON mode, all electrical components of the vehicle 12 can be used. In the ACC-ON mode, some electrical components such as audio can be used. In the ACC-OFF mode, except some electrical components such as a keyless entry system, electrical components cannot be used.

In the START mode, a starter motor is actuated to start the engine. After the engine start-up is completed, the transition to IG-ON is made. In the READY mode, the drive motor is allowed to be actuated and the vehicle 12 can be driven by the drive motor. The power mode when the hybrid vehicle and the electric vehicle are drivable is IG-ON and READY.

The vehicle 12 is equipped with a shift position sensor 62. The shift position sensor 62 detects a selected shift position. The parking position (P position), neutral position (N position), drive position (D position), reverse position (R position), and so on can be selected as shift positions.

The server device 14 has a computing unit 64 and a storage unit 66. The computing unit 64 is, for example, a processor such as a CPU or a GPU. The computing unit 64 has an information acquisition unit 68 and a transmission processing unit 70. The information acquisition unit 68 and the transmission processing unit 70 are realized by the computing unit 64 executing programs stored in the storage unit 66. At least part of the information acquisition unit 68 and the transmission processing unit 70 may be realized by an integrated circuit such as an ASIC or an FPGA. At least part of the information acquisition unit 68 and the transmission processing unit 70 may be realized by an electronic circuit including discrete devices.

The storage unit 66 is a computer-readable, non-transitory tangible storage medium. The storage unit 66 is composed of a volatile memory (not shown) and a nonvolatile memory (not shown). The volatile memory is, for example, RAM or the like. The non-volatile memory is, for example, ROM, flash memory, or the like. Data or the like is stored, for example, in the volatile memory. Programs, tables, maps, and the like are stored, for example, in the non-volatile memory. At least part of the storage unit 66 may be provided in the above-mentioned processor, integrated circuit, or the like. At least part of the storage unit 66 may be mounted in a device connected to the server device 14 via the network 16.

A plurality of vehicles 12 are registered in the server device 14, and the update status of the software of the ECU 18 of each vehicle 12 is managed. The server device 14 provides each vehicle 12 with the update data for updating the software of the ECU 18 of each vehicle 12.

### Flow of Software Update Process

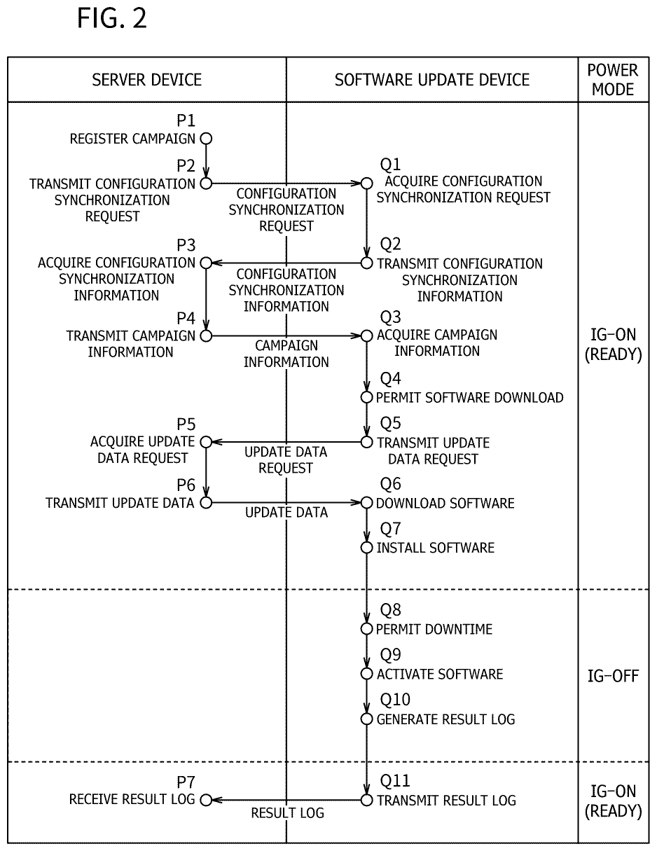

FIG. 2 is a flow diagram of a software update process according to one embodiment.

When the campaign is registered in the server device 14 (P1), the transmission processing unit 70 transmits a configuration synchronization request to the software update device 24 of the vehicle 12 (P2). The campaign, together with the update data for updating the software of the ECU 18, is registered in the server device 14 by a software developer of the ECU 18, a manufacturer of the vehicle 12, and so on.

When the information acquisition unit 32 of the software update device 24 acquires the configuration synchronization request (Q1), the information transmission unit 30 transmits the configuration synchronization information to the server device 14 (Q2). The configuration synchronization information includes information on a unique identifier assigned to each ECU 18 of the vehicle 12, information on a version of the software of each ECU 18, and the like.

When the information acquisition unit 68 of the server device 14 acquires the configuration synchronization information (P3), the transmission processing unit 70 transmits to the software update device 24 the campaign information on the software update process for each ECU 18 (P4).

The information acquisition unit 32 of the software update device 24 acquires the campaign information (Q3) and stores the campaign information in the campaign information storage unit 44. The display control unit 34 causes the display unit 58 of the IVI 50 to display the campaign information. The confirmation process for confirming with the user whether to permit software download is performed by the permission confirmation unit 36. In this confirmation process, when the user permits the software download (Q4), the transmission request unit 38 transmits an update data request to the server device 14 (Q5).

When the information acquisition unit 68 of the server device 14 acquires the update data request (P5), the transmission processing unit 70 transmits the update data to the software update device 24 (P6).

The update processing unit 40 of the software update device 24 acquires the update data and stores the update data in the storage unit 28, thereby downloading the software (Q6). Then, the update processing unit 40 loads the update data of the storage unit 28 into the ROM of the ECU 18 and installs the software (Q7).

Before the software activation starts, the permission confirmation unit 36 of the software update device 24 performs a confirmation process to confirm with the user whether to grant downtime. If the shift position detected by the shift position sensor 62 is “P” at the timing when the power mode is shifted from IG-ON (or READY) to IG-OFF, the confirmation process is executed. In this confirmation process, if the user permits downtime (Q8), the update processing unit 40 of the software update device 24 activates the software of the ECU 18 (Q9). The downtime indicates a time period during which the power mode of the vehicle 12 cannot be set to the START mode or the READY mode and the vehicle 12 cannot start traveling while the software activation is performed.

When the software activation of the ECU 18 is completed, the log generation unit 76 of the software update device 24 generates a result log (Q10). The log transmission unit 78 of the software update device 24 transmits the result log to the server device 14 (Q11). After the power mode transitions from IG-OFF to IG-ON (or READY), the result log is transmitted to the server device 14.

When the information acquisition unit 68 of the server device 14 acquires the result log (P7), the software update ends.

### Software Update Process

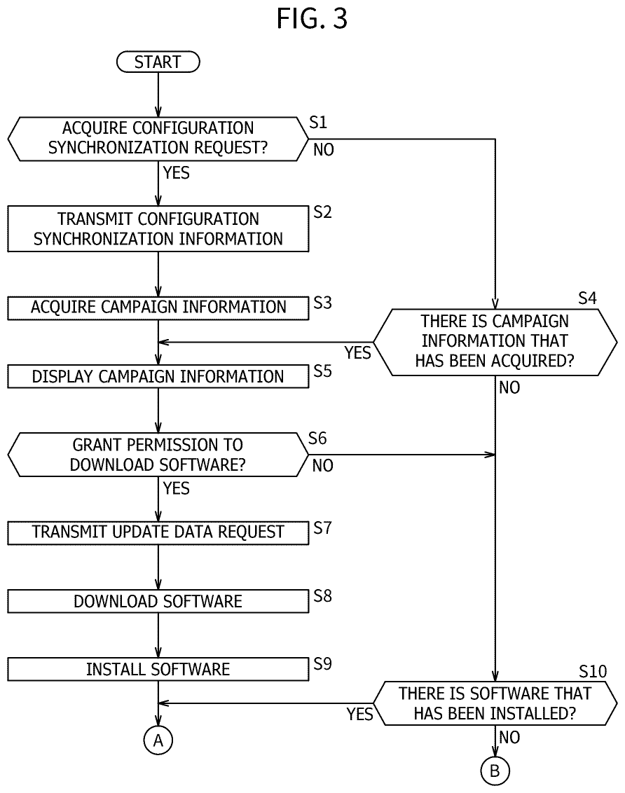

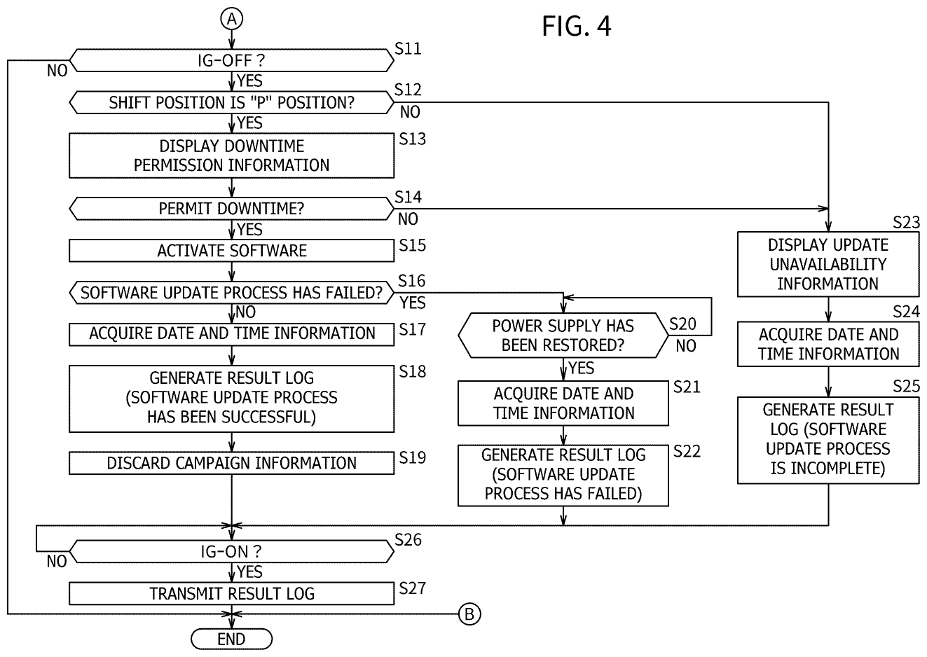

FIGS. 3 and 4 are a flow chart showing the software update process performed by the software update device 24 according to one embodiment. This process is executed at a predetermined cycle when the power mode is IG-ON (or READY).

In step S1, the software update device 24 determines whether or not the configuration synchronization request has been acquired from the server device 14. If it is determined that the configuration synchronization request has been acquired (step S1: YES), the process proceeds to step S2.

In step S2, the information transmission unit 30 of the software update device 24 transmits the configuration synchronization information to the server device 14. Then, the process proceeds to step S3.

In step S3, the information acquisition unit 32 of the software update device 24 acquires campaign information. Then, the process proceeds to step S5.

If it is determined in step S1 that no configuration synchronization request has been acquired (step S1: NO), the flow proceeds to step S4. In step S4, the software update device 24 determines whether or not there is campaign information that has been acquired in the campaign information storage unit 44. When it is determined that there is campaign information that has been acquired in the campaign information storage unit 44 (step S4: YES), the process proceeds to step S5.

In step S5, the display control unit 34 of the software update device 24 causes the display unit 58 of the IVI 50 to display the campaign information. Then, the process proceeds to step S6.

In step S6, the permission confirmation unit 36 of the software update device 24 determines whether the user has granted permission to download the software. If the software download is permitted (step S6: YES), the process proceeds to step S7.

In step S7, the transmission request unit 38 of the software update device 24 transmits an update data request to the server device 14. Then, the process proceeds to step S8.

In step S8, the update processing unit 40 of the software update device 24 downloads the software. Then, the process proceeds to step S9.

In step S9, the update processing unit 40 of the software update device 24 installs the software. Then, the process proceeds to step S11.

If it is determined in step S4 that there is no acquired campaign information in the campaign information storage unit 44 (step S4: NO), or if the software download is rejected in step S6 (step S6: NO), the process proceeds to step S10. In step S10, the update processing unit 40 of the software update device 24 determines whether there is software that has been installed. If it is determined that the installed software is present (step S10: YES), the process proceeds to step S11. If it is determined that there is no installed software (step S10: NO), the software update process is terminated.

In step S11, the update processing unit 40 of the software update device 24 determines whether the power mode of the vehicle 12 is IG-OFF. If it is determined that the power mode is IG-OFF (step S11: YES), the process proceeds to step S12. If it is determined that the power mode is not IG-OFF (step S11: NO), the software update process is terminated.

In step S12, the update processing unit 40 of the software update device 24 determines whether the shift position is the P position. If it is determined that the shift position is the P position (step S12: YES), the process proceeds to step S13.

In step S13, the display control unit 34 of the software update device 24 causes the display unit 58 of the IVI 50 to display downtime permission confirmation information. Then, the process proceeds to step S14.

In step S14, the permission confirmation unit 36 of the software update device 24 determines whether or not the user has permitted downtime. If it is determined that the downtime has been permitted (step S14: YES), the process proceeds to step S15.

In step S15, the update processing unit 40 of the software update device 24 activates the software. Then, the process proceeds to step S16.

In step S16, the update failure determination unit 72 of the software update device 24 determines whether the software update process has failed. As described above, when the software activation is aborted due to the failure of the power supply that supplies power to the ECU 18, the update failure determination unit 72 determines that the software update process has failed. On the other hand, when the software activation is completed, the update failure determination unit 72 determines that the software update process is successful.

If it is determined in step S16 that the software update process is successful (step S16: NO), the process proceeds to step S17. In step S17, the date and time information acquisition unit 74 of the software update device 24 acquires the date and time information. Then, the process proceeds to step S18.

In step S18, the log generation unit 76 of the software update device 24 generates a result log. Then, the process proceeds to step S19. The result log generated in step S18 includes information indicating that the software update process is successful and the date and time information acquired in step S17.

In step S19, the discarding processing unit 42 of the software update device 24 discards the campaign information stored in the campaign information storage unit 44. Then, the process proceeds to step S26.

If it is determined in step S16 that the software update has failed (step S16: YES), the process proceeds to step S20. In step S20, the date and time information acquisition unit 74 of the software update device 24 determines whether the power supply has been restored. If it is determined that the power supply has been restored (step S20: YES), the process proceeds to step S21. If it is determined that the power supply has not yet been restored (step S20: NO), the process of step S20 is repeated.

In step S21, the date and time information acquisition unit 74 of the software update device 24 acquires the date and time information. Then, the process proceeds to step S22.

In step S22, the log generation unit 76 of the software update device 24 generates a result log. Then, the process proceeds to step S26. The result log generated in step S22 includes information indicating that the software update process has failed and the date and time information acquired in step S21.

If it is determined in step S12 that the shift position is not the P position (step S12: NO), or if it is determined in step S14 that the downtime is rejected (step S14: NO), the process proceeds to step S23. In step S23, the display control unit 34 of the software update device 24 causes the display unit 58 to display update unavailability information indicating that software update cannot be updated. Then, the process proceeds to step S24.

In step S24, the date and time information acquisition unit 74 of the software update device 24 acquires the date and time information. Then, the process proceeds to step S25.

In step S25, the log generation unit 76 of the software update device 24 generates a result log. Then, the process proceeds to step S26. The result log generated in step S25 includes information indicating that the software update process is incomplete and also includes the date and time information acquired in step S24.

In step S26, the log transmission unit 78 of the software update device 24 determines whether the power mode of the vehicle 12 is IG-ON. If it is determined that the power mode is IG-ON (step S26: YES), the process proceeds to step S27. If it is determined that the power mode is not IG-ON (step S26: NO), the process of step S26 is repeated.

In step S27, the log transmission unit 78 of the software update device 24 transmits the result log to the server device 14. Then, the software update process is terminated.

### Campaign Application Process

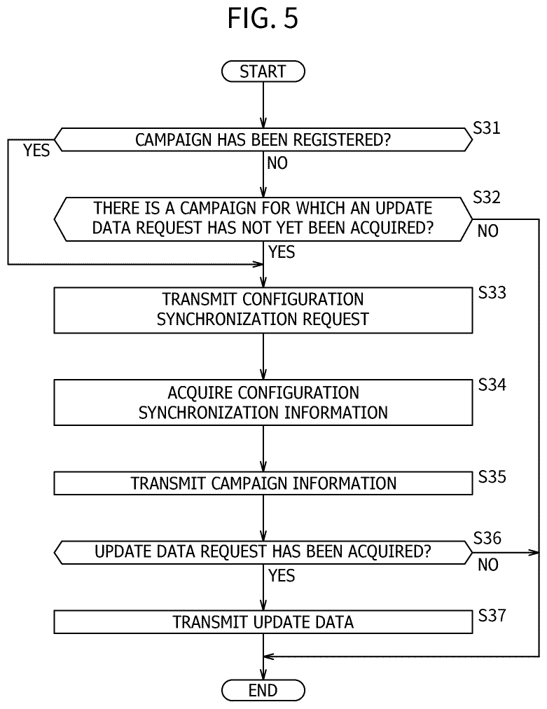

FIG. 5 is a flow chart showing a campaign application process performed by the server device 14 according to one embodiment. This process is executed at a predetermined period.

In step S31, the server device 14 determines whether a campaign has been registered. If it is determined that the campaign has been registered (step S31: YES), the process proceeds to step S33.

If it is determined that no campaign has been registered (step S31: NO), the process proceeds to step S32. In step S32, the server device 14 determines whether there is a campaign for which an update data request has not yet been acquired. If it is determined that there is a campaign for which the update data request has not yet been acquired (step S32: YES), the process proceeds to step S33. If it is determined that there is no campaign for which the update data request has not yet been acquired (step S32: NO), the campaign application process is terminated.

In step S33, the transmission processing unit 70 of the server device 14 transmits a configuration synchronization request to the vehicle 12. Then, the process proceeds to step S34.

In step S34, the information acquisition unit 68 of the server device 14 acquires the configuration synchronization information from the vehicle 12. Then, the process proceeds to step S35.

In step S35, the transmission processing unit 70 of the server device 14 transmits the campaign information to the vehicle 12. Then, the process proceeds to step S36.

In step S36, the server device 14 determines whether or not an update data request has been acquired. If it is determined that the update data request has been acquired (step S36: YES), the process proceeds to step S37. If it is determined that the update data request has not yet been acquired (step S36: NO), the campaign application process is terminated.

In step S37, the transmission processing unit 70 of the server device 14 transmits the update data to the vehicle 12. Then, the campaign application process is terminated.

### Operation of Software Update Device

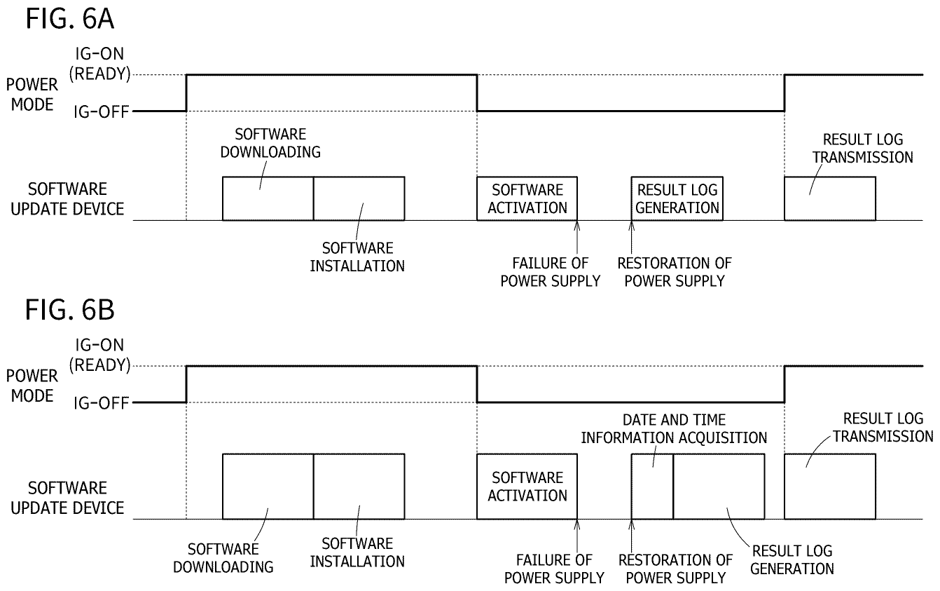

FIGS. 6A and 6B are diagrams for explaining the operation of the software update device 24. FIG. 6A illustrates the operation of a conventional software update device 24. FIG. 6B illustrates the operation of the software update device 24 according to one embodiment.

When the software activation is aborted due to the failure of the power supply that supplies power to the ECU 18, the log generation unit 76 of the software update device 24 generates a result log after the power supply is restored.

In the case of the conventional software update device 24, the process of acquiring the date and time information with the date and time information acquisition unit 74 is not performed after the power supply is restored. Therefore, the date and time information is not updated from the initial value, and the result log generated by the log generation unit 76 includes date and time information that does not conform to the format.

On the other hand, in the case of the software update device 24 in one embodiment, the date and time information acquisition unit 74 acquires the date and time information after the power supply is restored. Therefore, the date and time information is updated from the initial value, and the result log generated by the log generation unit 76 includes the date and time information conforming to the format.

### Other Embodiments

The software update system 10 of the above embodiment may be modified as explained below.

The log transmission unit 78 of the software update device 24 may determine, before transmitting the result log to the server device 14, whether or not a predetermined numerical value is included in the date and time information included in the result log. The predetermined numerical value is, for example, an initial value of the date and time information. The predetermined numerical value may be any numerical value that makes it possible to determine that the date and time information included in the result log does not conform to the format.

When the date and time information included in the result log includes a predetermined numerical value, the log transmission unit 78 may cancel the transmission of the result log. The date and time information acquisition unit 74 of the software update device 24 may reacquire the date and time information. The log generation unit 76 of the software update device 24 may regenerate a result log including the date and time information reacquired by the date and time information acquisition unit 74. The log generating unit 76 may transmit the result log regenerated by the log generating unit 76 to the server device 14.

When the date and time information contained in the event log includes the predetermined numerical value, the event log including the reacquired date and time information may be regenerated and the regenerated event log may be transmitted to the server device 14, in a similar manner as the above.

With respect to the above embodiments, the following supplementary notes are further disclosed.

### Supplementary Note 1

A software update system (10) of the present disclosure includes a vehicle (12) and a server device (14) configured to communicate with the vehicle via a network (16), and includes an update processing unit (40) configured to perform a software update process for an electronic control unit provided in the vehicle, an update failure determination unit (72) configured to determine whether the software update process has failed due to failure of a power supply that supplies power to the electronic control unit, a date and time information acquisition unit (74) configured to acquire date and time information, a log generation unit (76) configured to generate a log including information on the software update process and the date and time information acquired by the date and time information acquisition unit, and a log transmission unit (78) configured to transmit the log generated by the log generation unit to the server device, wherein, in a case where the software update process has been determined to have failed due to the failure of the power supply, the date and time information acquisition unit acquires the date and time information after the power supply is restored, the log generation unit generates the log based on the date and time information acquired by the date and time information acquisition unit after the power supply is restored, and the log transmission unit transmits to the server device the log generated based on the date and time information acquired by the date and time information acquisition unit after the power supply is restored.

### Supplementary Note 2

In the software update system described in supplementary note 1, the log transmission unit may determine, before transmitting the log to the server device, whether the date and time information included in the log includes a predetermined numerical value, and in a case where it is determined that the date and time information included in the log includes the predetermined numerical value, the log transmission unit may cancel transmission of the log, the date and time information acquisition unit may reacquire the date and time information, the log generation unit may regenerate the log including the date and time information reacquired by the date and time information acquisition unit, and the log transmission unit may transmit the log regenerated by the log generation unit to the server device.

### Supplementary Note 3

A software update system of the present disclosure includes a vehicle and a server device configured to communicate with the vehicle via a network, wherein the software update system includes an update processing unit configured to perform a software update process for an electronic control unit provided in the vehicle, a date and time information acquisition unit configured to acquire date and time information, a log generation unit configured to generate a log containing information related to the software update process and the date and time information acquired by the date and time information acquisition unit, and a log transmission unit configured to transmit the log generated by the log generation unit to the server device, wherein the log transmission unit determines, before transmitting the log, whether or not the date and time information included in the log includes a predetermined numerical value, and in a case where it is determined that the date and time information included in the log includes the predetermined numerical value, the log transmission unit cancels transmission of the log, the date and time information acquisition unit reacquires the date and time information, the log generation unit regenerates the log containing the date and time information reacquired by the date and time information acquisition unit, and the log transmission unit transmits the log regenerated by the log generation unit to the server device.

### Supplementary Note 4

A software update device (24) of the present disclosure is a software update device in the software update system described in supplementary note 1 or 2. The software update device includes the update processing unit, the update failure determination unit, the date and time information acquisition unit, the log generation unit, and the log transmission unit.

### Supplementary Note 5

A software update device of the present disclosure is the software update device in the software update system described in supplementary note 3. The software update device includes the update processing unit, the date and time information acquisition unit, the log generation unit, and the log transmission unit.

### Supplementary Note 6

A software update method of the present disclosure is the software update method for performing a software update process for an electronic control device provided in a vehicle. The method includes: an update processing step in which an update processing unit performs the software update process; an update failure determination step in which an update failure determination unit determines whether the software update processing has failed due to failure of a power supply that supplies power to the electronic control device; a date and time information acquisition step in which a date and time information acquisition unit acquires date and time information; a log generation step in which a log generation unit generates a log including information on the software update process and the date and time information acquired by the date and time information acquisition unit; and a log transmission step in which a log transmission unit transmits the log generated by the log generation unit to a server device, wherein, in a case where the software update process is determined to have failed due to the failure of the power supply; in the date and time information acquisition step, the date and time information acquisition unit acquires the date and time information after the power supply is restored; in the log generation step, the log generation unit generates the log based on the date and time information acquired by the date and time information acquisition unit after the power supply is restored; and in the log transmission step, the log transmission unit transmits the log generated based on the date and time information acquired by the date and time information acquisition unit to the server device.

### Supplementary Note 7

The software update method according to supplementary note 6 may further include, before the log transmission step, a date and time information determination step in which a date and time information determination unit determines whether the date and time information included in the log includes a predetermined numerical value, wherein, in a case where the date and time information included in the log includes the predetermined numerical value, there may be performed a log transmission canceling step of canceling transmission of the log generated in the log generation step, a date and time information reacquisition step of reacquiring the date and time information with the date and time information acquisition unit, a log regeneration step of regenerating the log including the date and time information reacquired by the date and time information acquisition unit, and a log retransmission step of transmitting the log regenerated in the log regeneration step to the server device with the log transmission unit.

### Supplementary Note 8

A program of the present disclosure causes a computer to execute the software update method described in supplementary note 6 or 7.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example and are not limited to these. The same applies to the case where numerical values or mathematical expressions are used in the description of the above-described embodiment.

1. A software update system comprising:
a vehicle;
a server device configured to communicate with the vehicle via a network; and
one or more processors that execute computer-executable instructions stored in a memory,
wherein the one or more processors execute the computer-executable instructions to cause the software update system to:
perform a software update process for an electronic control unit provided in the vehicle;
determine whether the software update process has failed due to failure of a power supply that supplies power to the electronic control unit;
in a case where it is not determined that the software update process has failed due to the failure of the power supply,
acquire date and time information;
generate a log including information on the software update process and the acquired date and time information;
transmit the generated log to the server device;
in a case where it is determined that the software update process has failed due to the failure of the power supply,
acquire the date and time information after the power supply is restored;
generate the log based on the date and time information acquired after the power supply is restored; and
transmit to the server device the log generated based on the date and time information acquired after the power supply is restored.

2. The software update system according to claim 1, wherein the one or more processors execute the computer-executable instructions to cause the software update system to:
determine, before transmitting the log to the server device, whether the date and time information included in the log includes a predetermined numerical value;
in a case where it is determined that the date and time information included in the log includes the predetermined numerical value,
cancel transmission of the log;
reacquire the date and time information;
regenerate the log including the reacquired date and time information; and
transmit the regenerated log to the server device.

3. A software update system comprising a vehicle and a server device configured to communicate with the vehicle via a network, the software update system comprising
one or more processors that execute computer-executable instructions stored in a memory,
wherein the one or more processors execute the computer-executable instructions to cause the software update system to:
perform a software update process for an electronic control unit provided in the vehicle;
acquire date and time information;
generate a log including information on the software update process and the acquired date and time information;
determine whether the date and time information included in the log includes a predetermined numerical value;
transmit the generated log to the server device in a case where it is not determined that the date and time information included in the log includes the predetermined numerical value;
in a case where it is determined that the date and time information included in the log includes the predetermined numerical value,
cancel transmission of the log;
reacquire the date and time information;
regenerate the log including the reacquired date and time information; and
transmit the regenerated log to the server device.

4. A software update device in the software update system according to claim 1, the software update device comprising
one or more processors that execute computer-executable instructions stored in a memory,
wherein the one or more processors execute the computer-executable instructions to cause the software update device to:
perform a software update process for an electronic control unit provided in the vehicle;
determine whether the software update process has failed due to failure of a power supply that supplies power to the electronic control unit;
in a case where it is not determined that the software update process has failed due to the failure of the power supply,
acquire the date and time information;
generate a log including information on the software update process and the acquired date and time information;
transmit the generated log to the server device;
in a case where it is determined that the software update process has failed due to the failure of the power supply,
acquire the date and time information after the power supply is restored;
generate the log based on the date and time information acquired after the power supply is restored; and
transmit to the server device the log generated based on the date and time information acquired after the power supply is restored.

5. A software update device in the software update system according to claim 3, the software update device comprising
one or more processors that execute computer-executable instructions stored in a memory,
wherein the one or more processors execute the computer-executable instructions to cause the software update device to:
perform a software update process for an electronic control unit provided in the vehicle;
acquire date and time information;
generate a log including information on the software update process and the acquired date and time information;
determine whether the date and time information included in the log includes a predetermined numerical value;
transmit the generated log to the server device in a case where it is not determined that the date and time information included in the log includes the predetermined numerical value;
in a case where it is determined that the date and time information included in the log includes the predetermined numerical value,
cancel transmission of the log;
reacquire the date and time information;
regenerate the log including the reacquired date and time information; and
transmit the regenerated log to the server device.

6. A software update method for performing a software update process for an electronic control unit provided in a vehicle, the method comprising:
performing the software update process;
determine whether the software update process has failed due to failure of a power supply that supplies power to the electronic control unit;
in a case where it is not determined that the software update process has failed due to the failure of the power supply,
acquiring date and time information;
generating a log including information on the software update process and the acquired date and time information;
transmitting the generated log to a server device;
in a case where it is determined that the software update process has failed due to the failure of the power supply,
acquiring the date and time information after the power supply is restored;
generating the log based on the date and time information acquired after the power supply is restored; and
transmitting to the server device the log generated based on the date and time information acquired after the power supply is restored.

7. The software update method according to claim 6, further comprising:
determining, before transmitting the log to the server device, whether the date and time information included in the log includes a predetermined numerical value;
in a case where it is determined that the date and time information included in the log includes the predetermined numerical value,
canceling transmission of the log;
reacquiring the date and time information;
regenerating the log including the reacquired date and time information; and
transmitting the regenerated log to the server device.

8. A computer-readable non-transitory storage medium storing a program, wherein the program causes a computer to execute the software update method according to claim 6.
